(19) United States
(12) Patent Application Publication
(10) Pub. No.: US 2003/0179420 A1
(43) Pub. Date: Sep. 25, 2003

(54) Lighting apparatus and image reading apparatus

(76) Inventor: Kouzou Fujino, Osaka (JP)

Correspondence Address: RATNERPRESTIA, P O BOX 980, VALLEY FORGE, PA, 19482-0980, US

(21) Appl. No.: 10/393,159

(22) Filed: Mar. 20, 2003

(30) Foreign Application Priority Data
Mar. 22, 2002 (JP) 2002-80,223

(51) Int. Cl. H04N 1/04

(52) U.S. Cl. 358/484

(57) ABSTRACT

The lighting apparatus includes an airspace arranged between the light source and the optical waveguide, having a thickness corresponding to one wavelength or more of the light outputted from the light source unit and to ½ or less of a thickness of the optical waveguide. The light outputted at an angle larger than that of the total reflection is totally reflected by an output surface of the light source unit, is returned into the light source unit, and is outputted from the output surface. The light outputted at an angle smaller than that of the total reflection is widened in an area ranging −90° to +90° of the airspace and reaches the entire end surface of the optical waveguide. The light entering the optical waveguide is totally reflected by a side surface of the optical waveguide and is propagated in the optical waveguide.

### BACKGROUND OF THE INVENTION

1. Field of the Invention

The present invention relates to a lighting apparatus for guiding light outputted from a light source into an optical waveguide so that the optical waveguide emits light, and an image reading apparatus using the lighting apparatus.

2. Description of the Related Art

An image sensor as a device for reading an original is used for image reading apparatuses such as a facsimile machine, a copying machine, and a scanner, and the like. The image sensor includes a reduction-type image sensor and a contact image sensor. The contact image sensor comprises a light source, an erect unity-magnification imaging optical system, a sensor, and the like. As compared with the reduction-type image sensor, generally, this contact image sensor has such a merit that the size of the image reading apparatus is compact, because a light-path length is shorter, and it is easily assembled in the image reading apparatus, because its troublesome optical adjustment is improved. In place of the reduction-type image sensor, the contact image sensor is variously used for the image reading apparatus.

A light source of the image reading apparatus using the above-mentioned contact image sensor uses a lighting apparatus comprising a light source unit including LED chips therein and a transparent optical waveguide. In the lighting apparatus, the light source unit is arranged at an end surface portion of the optical waveguide and a uniform line or area light source is provided to guide the light outputted from the light source unit to the optical waveguide from the end surface portion thereof.

FIG. 1 is a cross-sectional view of an arrangement portion of the light source unit in the lighting apparatus. A light source unit 10 comprises a printed board 16, an LED chip 14 arranged to a concave portion of the printed board 16, and a transparent resin 17 which covers the LED chip 14. The light source unit 10 is fixed to an optical waveguide 12 in contact therewith. Herein, an interface 11 exists between the transparent resin 17 and the optical waveguide 12.

The light outputted from the LED chip 14 in the light source unit 10 is incident on the optical waveguide 12 from the end surface portion of the optical waveguide 12. The light incident on the optical waveguide 12 is propagated in the optical waveguide 12 with iterated total reflection.

Referring to FIG. 1, the transparent resin 17 contains an epoxy resin (its refractive index n=1.5). Further, the optical waveguide 12 contains an acrylic resin (its refractive index n=1.5). When the light is incident on an airspace from medium having the refractive index of 1.5, an angle of the total reflection is 41.8° based on the Snell's law. Among the light outputted toward the interface 11 from the LED chip 14, light outputted at an angle of 49° with respect to the normal of the interface 11 is designated by reference symbol a and light outputted at an angle of 48° is designated by reference symbol b.

As mentioned above, the light source unit 10 is fixed to the optical waveguide 12 in contact therewith and the transparent resin 17 and the optical waveguide 12 have the same refractive index. Then, referring to FIG. 2, the light outputted from the LED chip 14 advances straight and is incident on the optical waveguide 12.

The light a is incident on the optical waveguide 12 and thereafter reaches a side surface of the optical waveguide 12. Then, since the light a is incident on the airspace of the side surface at an angle smaller than that of the total reflection, it is not reflected and is leaked outside. The amount of the leaked light becomes the loss of the amount of light, thereby causing the shortage of the amount of light near the light source unit 10 of the optical waveguide 12.

On the other hand, the light b reaches the side surface at an angle larger than that of the total reflection. Thus, the light b is reflected to the side surface and is propagated in the optical waveguide 12. Therefore, the light b is effectively used. However, light having the same operation as that of the light b is limited to one outputted at an angle ranging −(90°−angle of total reflection) to +(90°−angle of total reflection) with respect to the normal of the interface 11 from the light source unit 10. In the case of the medium having the refractive index n of 1.5, only light outputted at an angle ranging (−48.2°) to (+48.2°) has the same operation as that of the light b. Therefore, there is a problem that the light outputted from the light source unit 10 is not efficiently used.

### SUMMARY OF THE INVENTION

It is an object of the present invention to provide a lighting apparatus, in which the shortage of the amount of light is prevented near a light source unit and light outputted from the light source unit is efficiently used, and an image reading apparatus using the lighting apparatus.

According to the present invention, a lighting apparatus comprises: a light source which outputs light; an optical waveguide which guides the light outputted from the light source therein from an end surface portion; and an airspace arranged between the light source and the optical waveguide, having a thickness corresponding to one wavelength or more of the light outputted from the light source and to ½ or less of a thickness of the optical waveguide.

Preferably, the thickness of the airspace may be not more than 1.0 mm, or not less than 1 μm. Further, preferably, the optical waveguide may be an area optical waveguide or a line optical waveguide.

Furthermore, an image reading apparatus uses the above-mentioned lighting apparatus.

### BRIEF DESCRIPTION OF THE DRAWINGS

FIG. 1 is a cross-sectional view showing an arrangement portion of a light source unit at an end surface portion of an optical waveguide in a lighting apparatus;

FIG. 2 is a cross-sectional view of the lighting apparatus for explaining a status of the advance of light upon providing no airspace between the light source unit and the optical waveguide;

FIG. 3 is a cross-sectional view of the lighting apparatus for explaining a status of the advance of light upon providing an airspace between the light source unit and the optical waveguide;

FIG. 4 is a cross-sectional view showing an example of a line lighting apparatus having the airspace between the light source unit and the optical waveguide;

FIG. 5 is a cross-sectional view showing an example of an image reading apparatus using the line lighting apparatus having the airspace between the light source unit and the optical waveguide; and

FIG. 6 is a cross-sectional view showing an example of an image reading apparatus using an area lighting apparatus having the airspace between the light source unit and the optical waveguide.

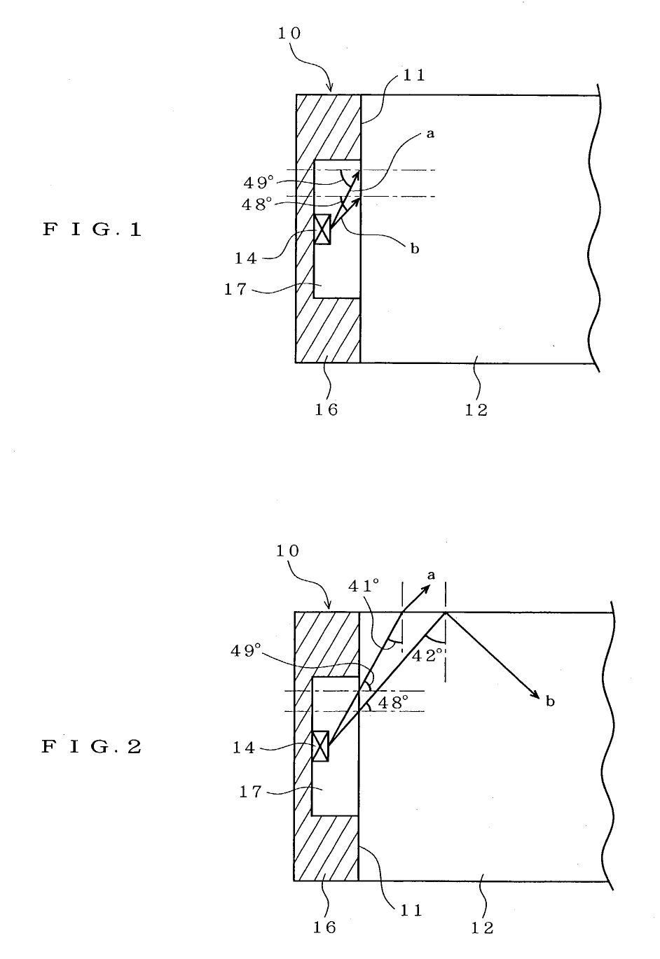

### DESCRIPTION OF THE PREFERRED EMBODIMENTS

Next, an embodiment according to the present invention will be described with reference to the drawings.

In a lighting apparatus according to the present invention, light outputted from a light source unit is efficiently guided in an optical waveguide by providing an airspace between the light source unit and the optical waveguide so that the using efficiency of the light is extremely improved.

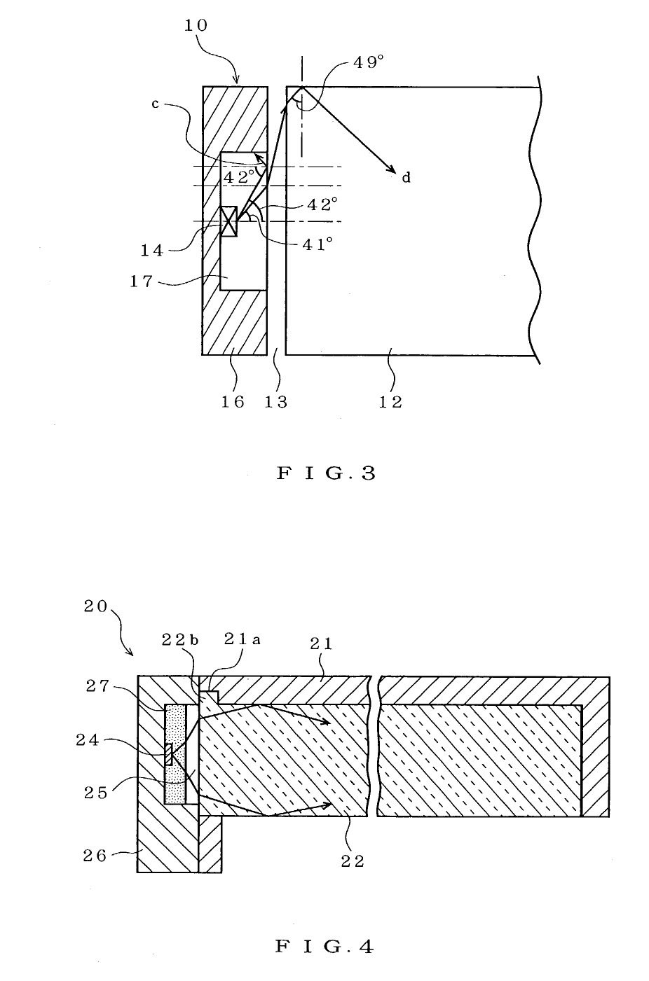

FIG. 3 is a cross-sectional view of the lighting apparatus for explaining a status of the advance of light when the airspace is provided between the light source unit and the optical waveguide. Referring to FIG. 3, a light source unit 10 comprises a printed board 16, an LED chip 14 arranged to a concave portion of the printed board 16, and a transparent resin 17 which covers the LED chip 14. An airspace 13 is provided between the light source unit 10 and the optical waveguide 12.

Referring to FIG. 3, the transparent resin 17 contains an epoxy resin (its refractive index n=1.5). Further, the optical waveguide 12 contains an acrylic resin (its refractive index n=1.5). When the light is incident on the airspace 13 from the transparent resin 17 and the optical waveguide 12 having the refractive index of 1.5, an angle of the total reflection is 41.8° based on the Snell's law.

Light c from the LED chip 14 outputted at an angle (of 42° in FIG. 3) larger than that of the total reflection with respect to the normal of an output surface of the light source unit 10, namely, the normal of the interface between the transparent resin 17 and the airspace 13 is totally reflected by the output surface of the light source unit 10, is returned into the light source unit 10, is further reflected therein, and is outputted from the output surface of the light source unit 10.

The light from the LED chip 14 outputted at an angle smaller than that of the total reflection with respect to the normal of the output surface of the light source unit 10 is outputted from the output surface of the light source unit 10 and is widened in the airspace 13 within an area ranging −90° to +90° with respect to the normal of the output surface of the light source unit 10. Thus, the light reaches the entire end surface of the optical waveguide 12 opposed to the light source unit 10. For example, as shown in FIG. 3, light d outputted from the LED chip 14 with an angle of 41° extremely near the angle of the total reflection is outputted from the light source unit 10 at an angle extremely near 90° with respect to the normal. Thus, the light reaches an adjacent portion near the side surface of the end surface of the optical waveguide 12. Since the light d incident on the optical waveguide 12 satisfies a condition of the total reflection, it is reflected to the side surface of the optical waveguide 12 and is propagated therein. Accordingly, the shortage of the amount of light is prevented near the light source unit 10 of the optical waveguide 12 and a uniform distribution of the amount of light is obtained in the optical waveguide 12.

Two advantages are obtained by providing the airspace between the light source unit and the optical waveguide as follows.

First, the light outputted with an angle larger than that of the total reflection is returned into the light source unit with the total reflection, is reflected therein, and is outputted from the output surface of the light source unit. Consequently, the loss of the amount of light is prevented. In other words, the almost all of the light outputted from the LED chip is inputted in the optical waveguide and is advantageously used.

Further, the light outputted at the angle smaller than that of the total reflection is outputted from the light source unit and then is widened in the airspace in the area ranging −90° to +90°. Thus, the light reaches the entire end surface of the optical waveguide opposed to the light source unit. The light incident on the optical waveguide is totally reflected onto the side surface of the optical waveguide and is propagated in the optical waveguide. Advantageously, the distribution of the amount of light is uniform.

Next, a thickness of the airspace will be described.

The thickness of the optical waveguide is several millimeters. If the light source unit is extremely far away from the optical waveguide, a ratio of the light leaked outside from a slit between the light source unit and the optical waveguide is increased. Consequently, there is troublesomeness that the amount of light incident on the optical waveguide is reduced and stray light leaked from the slit becomes serious.

When the thickness of the optical waveguide is 2.0 mm, preferably, the thickness of the airspace is 1.0 mm or less. A relationship between the thickness of the optical waveguide and the thickness of the optical waveguide is determined depending on a relative dimension of both the thickness and, therefore, the thickness of the airspace is preferably ½ or less of that of the optical waveguide.

Further, when the thickness of the optical waveguide is 3.5 mm, more preferably, the thickness of the airspace is 0.5 mm or less. Therefore, the thickness of the airspace is preferably 1/7 or less of that of the optical waveguide.

On the contrary, since the surface of the optical waveguide as a molding member generally has a surface coarseness, an interval between the light source unit and the optical waveguide is not equal to 1 μm or less. If the light source unit exists more near the optical waveguide by using a technology for mirror finishing, the interval between the light source unit and the optical waveguide must not be reduced to a wavelength of the light outputted from the light source. In a wavelength area, the Snell's law cannot be used, the effect of the near-field as the quantum effect appears, and a phenomenon of the leak of light is caused. This is equivalent to no airspace. Thus, preferably, the thickness of the airspace has one wavelength or more of the light outputted from the light source.

The structure in which the airspace is provided between the light source unit and the optical waveguide can be used for both the line lighting apparatus and the area lighting apparatus.

FIG. 4 is a diagram showing an example of the line lighting apparatus in which the airspace is provided between the light source unit and the optical waveguide, concretely, an enlarged cross-sectional view showing an end portion of a transparent stick optical waveguide and the light source unit.

The LED chip (light emitter) 24 is mounted on the printed board 26 by wire bonding, and is further protected by the transparent resin (epoxy resin) 27. The light outputted from the LED chip 24 is incident on the optical waveguide 22 from one end thereof. However, if an incident angle of the light entering the optical waveguide 22 is too large, the light is outputted to the outside from the optical waveguide 22. Then, the widening of the angle of the light toward the one end of the optical waveguide 22 is suppressed and the using efficiency of the light is improved by providing the airspace 25.

A raised portion 22b is formed at an end portion of the optical waveguide 22 opposing to the light source unit 20 and a case 21 includes a concave portion 21a which is fit to the raised portion 22b. The raised portion 22b and the concave portion 21a are provided so that the thickness of the airspace 25 formed between the one end surface of the optical waveguide 22 and the LED chip 24 of the light source unit 20 is constant by accurately positioning and fixing the end portion of the optical waveguide 22 opposing to the light source unit 20 upon accommodating the optical waveguide 22 in the case 21.

Next, a description is given of an image reading apparatus using the line lighting apparatus and the area lighting apparatus which have the airspace between the light source unit and the optical waveguide.

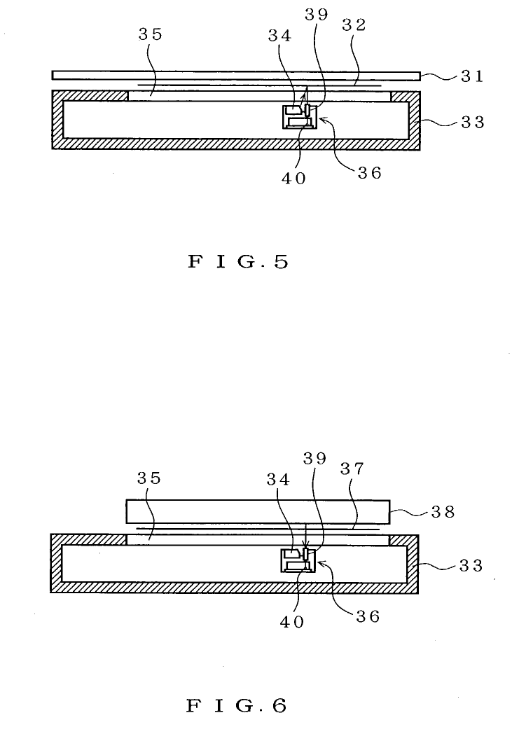

FIG. 5 is a cross-sectional view showing an example of an image reading apparatus using the line lighting apparatus having the above-mentioned airspace.

Referring to FIG. 5, the image reading apparatus comprises a contact image sensor 36 in a case 33. An upper surface of the case 33 comprises an original base glass 35. A sheet original 32 is placed onto the original base glass 35 and is pressed by an original cover 31.

The contact image sensor 36 comprises a rod lens array 39, a line sensor 40, and a line lighting apparatus (line light source) 34 having the airspace between the light source unit and the optical waveguide, and is arranged in the vicinity of the original base glass 35.

The contact image sensor 36 is reciprocatedly driven in a predetermined direction, thereby reading and scanning an original. Light outputted from the line light source 34 is reflected to the sheet original 32 and is inputted to the line sensor 40 via the rod lens array 39.

When the image reading apparatus is manufactured by providing the line lighting apparatus having the airspace for the contact image sensor, the amount of light is increased. Thus, the speed for reading the image is improved and a fast image reading apparatus is manufactured.

FIG. 6 is a cross-sectional view showing an example of the image reading apparatus using the area lighting apparatus having the airspace.

Referring to FIG. 6, the image reading apparatus comprises the contact image sensor 36 in the case 33. An upper surface of the case 33 comprises the original base glass 35. A film original 37 is placed onto the original base glass 35 and an area lighting apparatus 38 is placed upstream of the film original 37. The area lighting apparatus 38 is incorporated in an original cover (not shown) or is exchanged with the original cover upon reading the film original 37.

The contact image sensor 36 comprises the rod lens array 39 and the line sensor 40, and is arranged in the vicinity of the original base glass 35. The contact image sensor 36 incorporates the line lighting apparatus 34 necessary for reading the sheet original and is lit off upon reading the film original 37.

The contact image sensor 36 is reciprocatedly driven in a predetermined direction, thereby reading and scanning the original. Light outputted from the area light source 38 is transmitted through the film original 37 and is inputted to the line sensor 40 via the rod lens array 39.

When the image reading apparatus is manufactured by providing the area lighting apparatus having the airspace, the amount of light is increased. Thus, the speed for reading the image is improved and a fast image reading apparatus is manufactured.

The above lighting apparatus is not limited to the use for the image reading apparatuses such as the facsimile machine, the copying machine, and the scanner. Obviously, it can be used for various equipments such as a backlight of a liquid crystal display.

As mentioned above, the lighting apparatus of the present invention includes the airspace arranged between the light source and the optical waveguide, having the thickness corresponding to one wavelength or more of the light outputted from the light source unit and to ½ or less of the thickness of the optical waveguide. Therefore, the light outputted at the angle larger than that of the total reflection is totally reflected by the output surface of the light source unit, is returned into the light source unit, and is outputted again from the output surface. The light outputted at the angle smaller than that of the total reflection is widened in the area ranging −90° to +90° in the airspace and reaches the entire end surface of the optical waveguide. The light entering the optical waveguide is totally reflected by the side surface of the optical waveguide and is propagated in the optical waveguide. Accordingly, the shortage of the amount of light is prevented in the vicinity of the light source unit and the light outputted from the light source unit is efficiently used.

Since the amount of light is increased in the image reading apparatus using the above lighting apparatus of the present invention, the speed for reading the image is improved.

What is claimed is:

1. A lighting apparatus comprising:
a light source which outputs light;
an optical waveguide which guides the light outputted from said light source therein from an end surface portion; and
an airspace arranged between said light source and said optical waveguide, having a thickness corresponding to one wavelength or more of the light outputted from said light source and to ½ or less of a thickness of said optical waveguide.

2. A lighting apparatus according to claim 1, wherein the thickness of said airspace is one wavelength or more of the light outputted from said light source and is 1.0 mm or less.

3. A lighting apparatus according to claim 1, wherein the thickness of said airspace is 1 μm or more and is ½ or less of the thickness of said optical waveguide.

4. A lighting apparatus according to any one of claims 1 to 3, wherein said optical waveguide is an area optical waveguide or a line optical waveguide.

5. An image reading apparatus using a lighting apparatus according to claim 4.
